(19) United States
(12) Patent Application Publication
(10) Pub. No.: US 2013/0014225 A1
(43) Pub. Date: Jan. 10, 2013

(54) COMMUNICATION APPARATUS, COMMUNICATION METHOD, SERVICE OFFERING APPARATUS, SERVICE OFFERING METHOD, COORDINATION APPARATUS, COORDINATION METHOD, PROGRAM, TRANSMISSION/RECEPTION SYSTEM, AND TRANSMISSION/RECEPTION METHOD

(75) Inventor: YUICHI KAGEYAMA, Tokyo (JP)

(73) Assignee: Sony Corporation, Tokyo (JP)

(21) Appl. No.: 13/527,902

(22) Filed: Jun. 20, 2012

(30) Foreign Application Priority Data
Jul. 4, 2011 (JP) 2011-147931

(51) Int. Cl. G06F 21/00

(52) U.S. Cl. 726/4

(57) ABSTRACT

A communication apparatus includes an input part configured to input user identification information identifying a user ready to receive a service offered by a service offering apparatus via a network; an acquisition part configured to acquire device identification information from a coordination apparatus capable of offering the service in coordination with the service offering apparatus, the device identification information identifying the coordination apparatus; a transmission part configured to transmit to the service offering apparatus the user identification information input by the input part and the device identification information acquired by the acquisition part; a reception part configured to receive from the service offering apparatus authorization information indicating that the coordination of the coordination apparatus is authorized upon offering of the service responding to the transmission of the user identification information and the device identification information, and a notification part configured to notify the coordination apparatus of the authorization information received.

### BACKGROUND

The present disclosure relates to a communication apparatus, a communication method, a service offering apparatus, a service offering method, a coordination apparatus, a coordination method, a program, a transmission/reception system, and a transmission/reception method. More particularly, the disclosure relates to a communication apparatus, a communication method, a service offering apparatus, a service offering method, a coordination apparatus, a coordination method, a program, a transmission/reception system, and a transmission/reception method for allowing services offered by the service offering apparatus to be used securely in coordination with the coordination apparatus based on simple settings using the communication apparatus.

For example, electrical appliances in the household may be interconnected to form a home network (see Japanese Patent Laid-open No. 2004-173148, called Patent Document 1 hereunder; or Japanese Patent Laid-open No. 2006-178976, called Patent Document 2 hereunder).

If any of the electrical appliances on the home network is used as a coordination apparatus coordinating with a service offering apparatus on the Internet (i.e., server), a particular service (e.g., the service of allowing TV programs recorded by a home video recorder to be viewed on the Web) can be brought about thereby.

The service above may be implemented when the coordination apparatus as an electrical appliance on the home network carries out the API (application program interface) of the service offering apparatus on the Internet, for example.

To execute the API generally requires authorization by the service offering apparatus. There exist two major methods for obtaining authorization from the service offering apparatus: password method and access token method.

According to the password method, the coordination apparatus is authorized to execute the API if the user ID and password sent from the coordination apparatus match the user ID and password previously registered (i.e., held) in the service offering apparatus.

According to the access token method, the coordination apparatus is authorized to carry out the API upon receipt of an access token distributed by the service offering apparatus, the access token indicating that the execution of the API is authorized within a predetermined range necessary for implementing the service of interest.

There are a number of methods for distributing the access token, such as the xAuth method requiring the coordination apparatus to manage the user ID and password by itself, and the serial number input method calling for the input of a serial number to the service offering apparatus over the Internet.

There also exists the so-called OAuth method. This is a method for use between service offering apparatuses and thus is not generally used between the coordinate apparatus and the service offering apparatus.

### SUMMARY

If, for example, any one of a plurality of coordination apparatuses changes its password registered in the service offering apparatus through the use of a communication apparatus communicable with the service offering apparatus via a network, the above-mentioned password method usually requires each of the coordination apparatuses executing the API to change the password under its individual management. This can involve making very complicated settings upon use of the service.

For that reason, the user may forgo changing the password managed by each of the coordination apparatuses. If the passwords registered in the service offering apparatus are thus left unchanged, security-related problems can occur.

Also, the password method usually requires that the user ID and password held in each coordination apparatus be managed securely. That is, if the user ID and password are stolen from any one of the coordination apparatuses, the service of interest can be abused. Implementing suitable countermeasures against such eventualities can be a heavy burden on the coordination apparatuses.

Also, when the access token is distributed by the xAuth method exemplifying the above-mentioned access token method, it is necessary for each of a plurality of coordination apparatuses to manage its user ID and password securely. This method can entail the same problems as the above-described password method.

In addition, when the access token is distributed by the serial number input method exemplifying the access token method above, it is necessary for each of the coordination apparatuses to access the service offering apparatus in order to input the serial number to the service offering apparatus. This has proved to be a very complicated procedure.

Furthermore, if the serial number is inadvertently known to a third party, the third party can acquire the access token by inputting the serial number. This can also give rise to security-related problems.

The present disclosure has been made in view of the above circumstances and provides innovative arrangements for allowing the service offered by a service offering apparatus to be used securely in coordination with a coordination apparatus based on simple settings using a communication apparatus.

According to one embodiment of the present disclosure, there is provided a communication apparatus including:

an input part configured to input user identification information identifying a user ready to receive a service offered by a service offering apparatus via a network;

an acquisition part configured to acquire device identification information from a coordination apparatus capable of offering the service in coordination with the service offering apparatus, the device identification information identifying the coordination apparatus;

a transmission part configured to transmit to the service offering apparatus the user identification information input by the input part and the device identification information acquired by the acquisition part;

a reception part configured to receive from the service offering apparatus authorization information indicating that the coordination of the coordination apparatus is authorized upon offering of the service in response to the transmission of the user identification information and the device identification information; and

a notification part configured to notify the coordination apparatus of the authorization information received.

Preferably, the notification part may communicate the received authorization information to the coordination apparatus identified by the device identification information that is fixed.

Preferably, the acquisition part may acquire from the coordination apparatus the device identification information along with coordination side-generated information generated by the coordination apparatus, and the transmission part may transmit to the service offering apparatus the user identification information input by the input part, as well as the device identification information and the coordination side-generated information acquired by the acquisition part.

Preferably, the communication apparatus according to the disclosure may further include a supply part configured to supply the coordination apparatus with designated service information indicative of one of a plurality of services which is designated by the user. The acquisition part may acquire the device identification information from the coordination apparatus capable of offering the service designated by the user in coordination with the service offering apparatus in response to the supply of the designated service information to the coordination apparatus.

According to another embodiment of the present disclosure, there is provided a communication method for use with a communication apparatus communicating user identification information identifying a user, the communication method including:

acquiring through the communication apparatus device identification information from a coordination apparatus capable of offering a service in coordination with a service offering apparatus offering the service via a network, the device identification information identifying the coordination apparatus;

transmitting to the service offering apparatus the user identification information input by an input part of the communication apparatus inputting the user identification information identifying the user ready to receive the service from the service offering apparatus, and the device identification information acquired;

receiving from the service offering apparatus authorization information indicating that the coordination of the coordination apparatus is authorized upon offering of the service in response to the transmission of the user identification information and the device identification information; and

notifying the coordination apparatus of the authorization information received.

According to a further embodiment of the present disclosure, there is provided a program for causing a computer to function as an apparatus including:

an acquisition part configured to acquire device identification information from a coordination apparatus capable of offering a service in coordination with a service offering apparatus offering the service via a network, the device identification information identifying the coordination apparatus;

a transmission control part configured to transmit to the service offering apparatus the user identification information input by an input part of the communication apparatus inputting the user identification information identifying a user ready to receive the service from the service offering apparatus, and the device identification information acquired by the acquisition part;

a reception control part configured to receive from the service offering apparatus authorization information indicating that the coordination of the coordination apparatus is authorized upon offering of the service in response to the transmission of the user identification information and the device identification information; and

a notification control part configured to notify the coordination apparatus of the authorization information received.

According to the disclosure embodied as outlined in the preceding paragraphs, the device identification information identifying the coordination apparatus is acquired from the coordination apparatus capable of offering the service in coordination with the service offering apparatus offering the service via the network. Transmitted to the service offering apparatus is the user identification information input by the input part of the communication apparatus inputting the user identification information identifying the user ready to receive the service from the service offering apparatus, as well as the device identification information acquired by the acquisition part of the communication apparatus. Received from the service offering apparatus is the authorization information indicating that the coordination of the coordination apparatus is authorized upon offering of the service in response to the transmission of the user identification information and the device identification information. The coordination apparatus is notified of the authorization information received.

According to an even further embodiment of the present disclosure, there is provided a service offering apparatus for offering a service via a network, the service offering apparatus including:

a reception part configured to receive device identification information and user identification information from a communication apparatus to which the user identification information identifying a user ready to receive the service is input and which is supplied with the device identification information identifying a coordination apparatus capable of offering the service in coordination with the service offering apparatus;

a storage control part configured to store the device identification information in association with the user identification information;

a transmission part configured to transmit to the communication apparatus authorization information indicating that the coordination of the coordination apparatus is authorized upon offering of the service in response to the storage of the device identification information in association with the user identification information;

an acquisition part configured to acquire from the coordination apparatus the authorization information received by the communication apparatus and communicated to the coordination apparatus; and

a supply part configured to supply the coordination apparatus with coordination use information to be used by the coordination apparatus upon offering of the service in accordance with the authorization information acquired.

Preferably, the coordination apparatus may generate coordination side-generated information indicative of a random character string. The acquisition part may acquire from the coordination apparatus the first coordination side-generation information and the first device identification information. The reception part may receive the second coordination side-generated information and the second device identification information from the communication apparatus to which the second coordination side-generated information is supplied by the coordination apparatus. Upon coincidence between the acquired first coordination side-generated information and first device identification information on the one hand and the received second coordination side-generated information and second device identification information on the other hand, the storage control part may store the device identification information in association with the user identification information.

Preferably, the service offering apparatus according to the disclosure may further include a generation part configured to generate service side-generated information indicative of a random character string, and another transmission part configured to transmit the first service side-generated information to the coordination apparatus. The acquisition part may receive the first authorization information and the second service side-generated information from the coordination apparatus having received the second service side-generated information from the other transmission part. Upon coincidence between the first service side-generated information and the second authorization information transmitted to the communication apparatus on the one hand and the second service side-generated information and the second authorization information on the other hand, the supply part may supply the coordination apparatus with the coordination use information.

Preferably, the service offering apparatus according to the disclosure may further include another reception part configured to receive from coordination apparatus the device identification information and designated service information indicative of the service designated by the user of the communication apparatus, and a determination part configured to determine whether the coordination apparatus can coordinate when the service designated by the designated service information is offered, on the basis of the device identification information received from the coordination apparatus. The supply part may supply the coordination apparatus with a result of the determination made by the determination part.

According to a still further embodiment of the present disclosure, there is provided a service offering method for use with a service offering apparatus offering a service via a network, the service offering method including:

receiving device identification information and user identification information from a communication apparatus to which the user identification information identifying a user ready to receive the service is input and which is supplied with the device identification information identifying a coordination apparatus capable of offering the service in coordination with the service offering apparatus;

performing control to store the device identification information in association with the user identification information;

transmitting to the communication apparatus authorization information indicating that the coordination of the coordination apparatus is authorized upon offering of the service in response to the storage of the device identification information in association with the user identification information;

acquiring from the coordination apparatus the authorization information received by the communication apparatus and communicated to the coordination apparatus; and

supplying the coordination apparatus with coordination use information to be used by the coordination apparatus upon offering of the service in accordance with the authorization information acquired.

According to a yet further embodiment of the present disclosure, there is provided a program for causing a computer of a service offering apparatus offering a service via a network to function as an apparatus including:

a reception control part configured to receive device identification information and user identification information from a communication apparatus to which the user identification information identifying a user ready to receive the service is input and which is supplied with the device identification information identifying a coordination apparatus capable of offering the service in coordination with the service offering apparatus;

a storage control part configured to store the device identification information in association with the user identification information;

a transmission control part configured to transmit to the communication apparatus authorization information indicating that the coordination of the coordination apparatus is authorized upon offering of the service in response to the storage of the device identification information in association with the user identification information;

an acquisition control part configured to acquire from the coordination apparatus the authorization information received by the communication apparatus and communicated to the coordination apparatus; and

a supply control part configured to supply the coordination apparatus with coordination use information to be used by the coordination apparatus upon offering of the service in accordance with the authorization information acquired.

According to the disclosure embodied as outlined in the preceding paragraphs, the device identification information and the user identification information are received from the communication apparatus to which the user identification information identifying the user ready to receive the service is input and which is supplied with the device identification information identifying the coordination apparatus capable of offering the service in coordination with the service offering apparatus. The device identification information is stored in association with the user identification information. Transmitted to the communication apparatus is the authorization information indicating that the coordination of the coordination apparatus is authorized upon offering of the service in response to the storage of the device identification information in association with the user identification information. Acquired from the coordination apparatus is the authorization information received by the communication apparatus and communicated to the coordination apparatus. The coordination apparatus is supplied with the coordination use information to be used by the coordination apparatus upon offering of the service in accordance with the authorization information acquired.

According to another embodiment of the present disclosure, there is provided a coordination apparatus capable of offering a service in coordination with a service offering apparatus offering the service via a network, the coordination apparatus including:

a supply part configured to supply device identification information identifying the coordination apparatus to a communication apparatus to which user identification information identifying a user ready to receive the service is input;

a transmission part configured to transmit to the service offering apparatus authorization information which is communicated from the communication apparatus and which indicates that the coordination of the coordination apparatus is authorized upon offering of the service; and

a reception part configured to receive from the service offering apparatus coordination use information to be used for coordination with the service offering apparatus in response to the transmission of the authorization information.

Preferably, the reception part may receive from the service offering apparatus service side-generated information generated by the service offering apparatus, and the transmission part may transmit to the service offering apparatus the authorization information communicated from the communication apparatus along with the service side-generated information received.

Preferably, the transmission part may transmit designated service information and the device identification information to the service offering apparatus offering the service designated by the designated service information received from the communication apparatus. The reception part may receive, from the service offering apparatus having received the designated service information and the device identification information, a result of the determination of whether the coordination of the coordination apparatus is possible on the basis of the designated service information and the device identification information. The supply part may supply the communication apparatus with the device identification information in response to the receipt of the result of the determination that the coordination of the coordination apparatus is possible.

According to a further embodiment of the present disclosure, there is provided a coordination method for use with a coordination apparatus capable of offering a service in coordination with a service offering apparatus offering the service via a network, the coordination method including:

supplying device identification information identifying the coordination apparatus to a communication apparatus to which user identification information identifying a user ready to receive the service is input;

transmitting to the service offering apparatus authorization information which is communicated from the communication apparatus and which indicates that the coordination of the coordination apparatus is authorized upon offering of the service; and

receiving from the service offering apparatus coordination use information to be used for coordination with the service offering apparatus in response to the transmission of the authorization information.

According to an even further embodiment of the present disclosure, there is provided a program for causing a computer of a coordination apparatus capable of offering a service in coordination with a service offering apparatus offering the service via a network to function as an apparatus including:

a supply control part configured to supply device identification information identifying the coordination apparatus to a communication apparatus to which user identification information identifying a user ready to receive the service is input;

a transmission control part configured to transmit to the service offering apparatus authorization information which is communicated from the communication apparatus and which indicates that the coordination of the coordination apparatus is authorized upon offering of the service; and

a reception control part configured to receive from the service offering apparatus coordination use information to be used for coordination with the service offering apparatus in response to the transmission of the authorization information.

According to the disclosure embodied as outlined in the preceding paragraphs, the device identification information identifying the coordination apparatus is supplied to the communication apparatus to which the user identification information identifying the user ready to receive the service is input. Transmitted to the service offering apparatus offering the service is the authorization information which is communicated from the communication apparatus and which indicates that the coordination of the coordination apparatus is authorized upon offering of the service. Received from the service offering apparatus is the coordination use information to be used for coordination with the service offering apparatus in response to the transmission of the authorization information.

According to a still further embodiment of the present disclosure, there is provided a transmission/reception system including:

a communication apparatus communicating user identification information identifying a user;

a service offering apparatus offering a service to the user via a network; and

a coordination apparatus capable of coordinating with the service offering apparatus;

the communication apparatus including
an input part configured to input the user identification information identifying the user ready to receive the service offered by the service offering apparatus,
a first acquisition part configured to acquire device identification information from the coordination apparatus, the device identification information identifying the coordination apparatus,
a first transmission part configured to transmit to the service offering apparatus the user identification information input by the input part and the device identification information acquired by the first acquisition part,
a first reception part configured to receive from the service offering apparatus authorization information indicating that the coordination of the coordination apparatus is authorized upon offering of the service in response to the transmission of the user identification information and the device identification information, and
a notification part configured to notify the coordination apparatus of the authorization information received,

the service offering apparatus including
a second reception part configured to receive the device identification information and the user identification information from the communication apparatus,
a storage control part configured to store the device identification information in association with the user identification information,
a second transmission part configured to transmit to the communication apparatus the authorization information in response to the storage of the device identification information in association with the user identification information,
a second acquisition part configured to acquire from the coordination apparatus the authorization information received by the communication apparatus and communicated to the coordination apparatus, and
a first supply part configured to supply the coordination apparatus with coordination use information to be used by the coordination apparatus upon offering of the service in accordance with the authorization information acquired, and

the coordination apparatus including
a second supply part configured to supply the device identification information to the communication apparatus,
a third transmission part configured to transmit to the service offering apparatus the authorization information communicated from the communication apparatus, and
a third reception part configured to receive the coordination use information from the service offering apparatus in response to the transmission of the authorization information.

According to a yet further embodiment of the present disclosure, there is provided a transmission/reception method for use with a transmission/reception system including a communication apparatus communicating user identification information identifying a user, a service offering apparatus offering a service to the user via a network, and a coordination apparatus capable of coordinating with the service offering apparatus, the transmission/reception method including:

by the communication apparatus,

acquiring firstly device identification information from the coordination apparatus, the device identification information identifying the coordination apparatus;

transmitting firstly to the service offering apparatus the user identification information input by an input part of the communication apparatus inputting the user identification information identifying the user ready to receive the service from the service offering apparatus, and the device identification information acquired firstly;

receiving firstly from the service offering apparatus authorization information indicating that the coordination of the coordination apparatus is authorized upon offering of the service in response to the transmission of the user identification information and the device identification information;

notifying the coordination apparatus of the authorization information received;

by the service offering apparatus,

receiving secondly the device identification information and the user identification information from the communication apparatus;

performing control to store the device identification information in association with the user identification information;

transmitting secondly to the communication apparatus the authorization information in response to the storage of the device identification information in association with the user identification information;

acquiring secondly from the coordination apparatus the authorization information received by the communication apparatus and communicated to the coordination apparatus;

supplying firstly the coordination apparatus with coordination use information to be used by the coordination apparatus upon offering of the service in accordance with the authorization information acquired;

by the coordination apparatus,

supplying secondly the device identification information to the communication apparatus;

transmitting thirdly to the service offering apparatus the authorization information communicated from the communication apparatus; and

receiving thirdly from the service offering apparatus the coordination use information in response to the transmission of the authorization information.

According to the disclosure embodied as outlined in the preceding paragraphs, the device identification information from the coordination apparatus is acquired through the communication apparatus, the device identification information identifying the coordination apparatus. Transmitted to the service offering apparatus is the user identification information input by the input part of the communication apparatus inputting the user identification information identifying the user ready to receive the service from the service offering apparatus, along with the device identification information acquired firstly. Received from the service offering apparatus is the authorization information indicating that the coordination of the coordination apparatus is authorized upon offering of the service in response to the transmission of the user identification information and the device identification information. The coordination apparatus is notified of the authorization information thus received. The service offering apparatus receives the device identification information and the user identification information from the communication apparatus. The device identification information is stored in association with the user identification information. The authorization information is transmitted to the communication apparatus in response to the storage of the device identification information in association with the user identification information. Acquired from the coordination apparatus is the authorization information received by the communication apparatus and communicated to the coordination apparatus. The coordination apparatus is supplied with the coordination use information to be used by the coordination apparatus upon offering of the service in accordance with the authorization information acquired. The coordination apparatus supplies the device identification information to the communication apparatus. The authorization information communicated from the communication apparatus is transmitted to the service offering apparatus. The coordination use information is received from the service offering apparatus in response to the transmission of the authorization information.

According to the present disclosure embodied as outlined above, services can be utilized securely based on simple settings.

### BRIEF DESCRIPTION OF THE DRAWINGS

FIG. 1 is a block diagram showing a typical configuration of a transmission/reception system embodying the present disclosure;

FIG. 2 is an explanatory view outlining processes performed by the transmission/reception system of FIG. 1;

FIG. 3 is a schematic view showing a typical login screen;

FIG. 4 is a schematic view showing a typical device registration screen;

FIG. 5 is a schematic view showing a typical new user registration screen;

FIG. 6 is a block diagram showing a typical configuration of a mobile phone;

FIG. 7 is a flowchart explanatory of a registration stand-in process performed by the mobile phone;

FIG. 8 is a block diagram showing a typical configuration of a weight scale;

FIG. 9 is a flowchart explanatory of an access token acquisition process performed by the weight scale;

FIG. 10 is a block diagram showing a typical configuration of a service offering server;

FIG. 11 is a flowchart explanatory of an access token issuing process performed by the service offering server;

FIG. 12 is an explanatory view outlining other processes performed by the transmission/reception system of FIG. 1; and

FIG. 13 is a block diagram showing a typical configuration of a computer.

### DETAILED DESCRIPTION OF THE PREFERRED EMBODIMENTS

Some preferred embodiments (called the embodiment or the preferred embodiment hereunder) of the present disclosure will now be described below. The description will be given under the following headings:

1. Preferred embodiment (an example in which a mobile phone 21 stands in for a weight scale 22 to register the weight scale 22 with a service offering server 25), and

### 2. Variations.

### 1. Preferred Embodiment

### [Typical Configuration of the Transmission/Reception System 1]

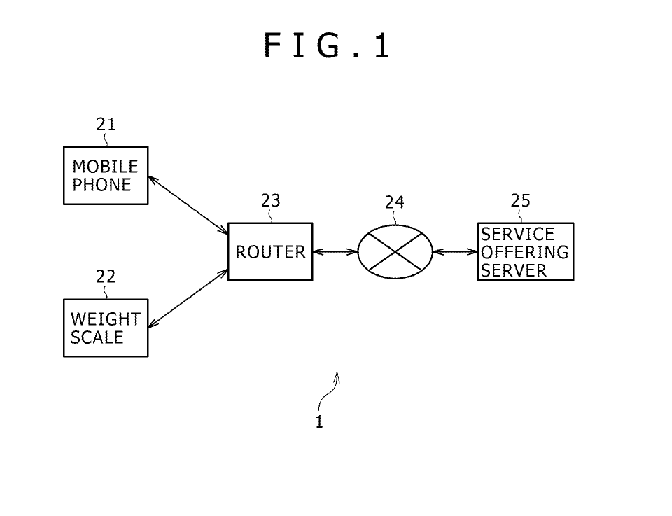

FIG. 1 shows a typical configuration of a transmission/reception system 1 according to the embodiment of the present disclosure.

The transmission/reception system 1 is made up of a mobile phone 21, a weight scale 22, a router 23, a network 24 exemplified by the Internet, and a service offering server 25.

The mobile phone 21 stands in for the weight scale 22 to perform a registration stand-in process for registering the weight scale 22 with the service offering server 25. The registration allows the service offering server 25 to coordinate with the weight scale 22 in offering a service to the user of the mobile phone 21 for example, the service being determined beforehand by the manufacturer or the like of the weight scale 22.

For example, the mobile phone 21 may access the service offering server 25 to view a graphic representation of weights or other data measured by the weight scale. In this manner, the user of the mobile phone 21 can receive the service of getting graphically represented weights and other data measured by the weight scale 22 viewed on the network 24.

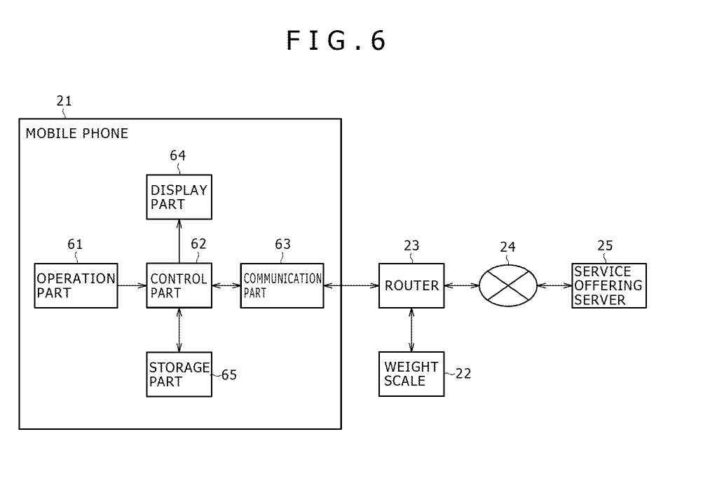

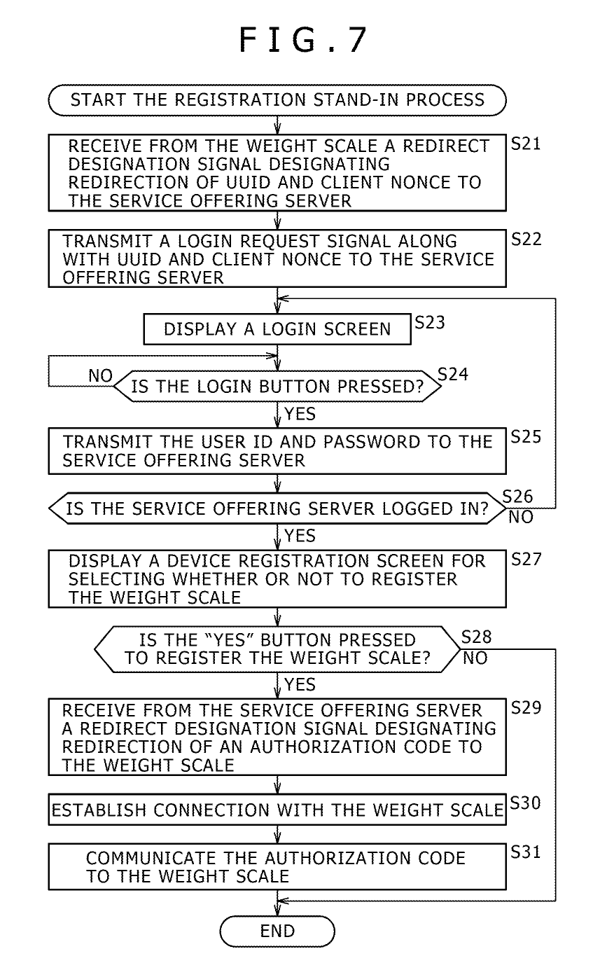

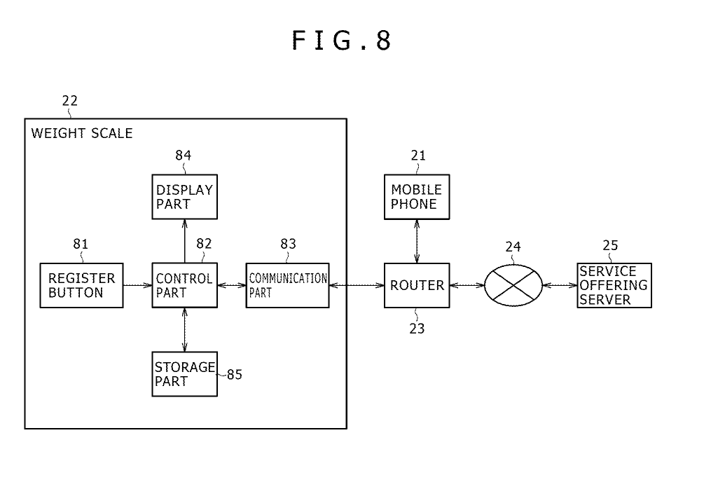

The mobile phone 21 will be discussed later in more detail by reference to FIGS. 6 and 7.

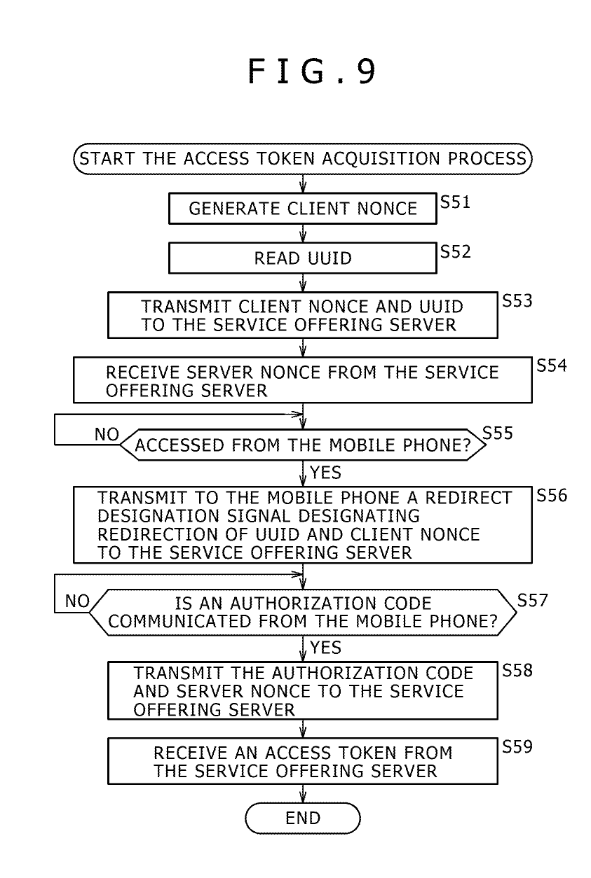

When the mobile phone 21 has registered the weight scale 22 with the service offering server 25, the weight scale 22 performs an access token acquisition process for acquiring an access token from the service offering server 25 via the mobile phone 21, the access token being used to access the service offering server 25. The weight scale 22 will be discussed later in more detail by reference to FIGS. 8 and 9.

The router 23 relays data to be exchanged among the mobile phone 21, weight scale 22, and network 24. The mobile phone 21, weight scale 22, and router 23 are installed in the user's home. The router 23 interconnects the mobile phone 21 with the weight scale 22 to form a home network.

The mobile phone 21 may be carried around by the user. When brought into the user's home, the mobile phone 21 connects with the router 23 to form part of the home network.

The network 24 may relay data exchanged between the router 23 and the service offering server 25, for example.

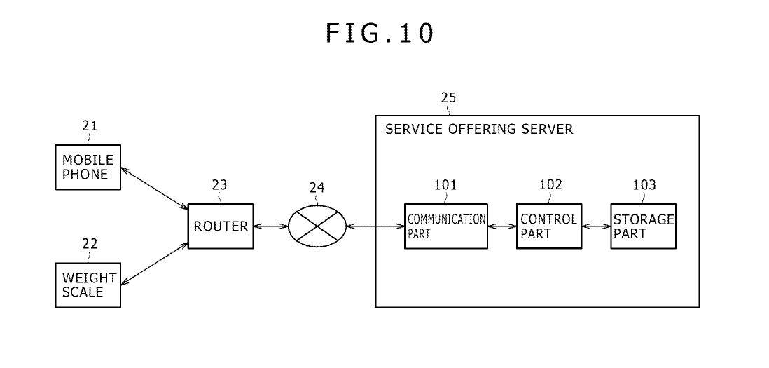

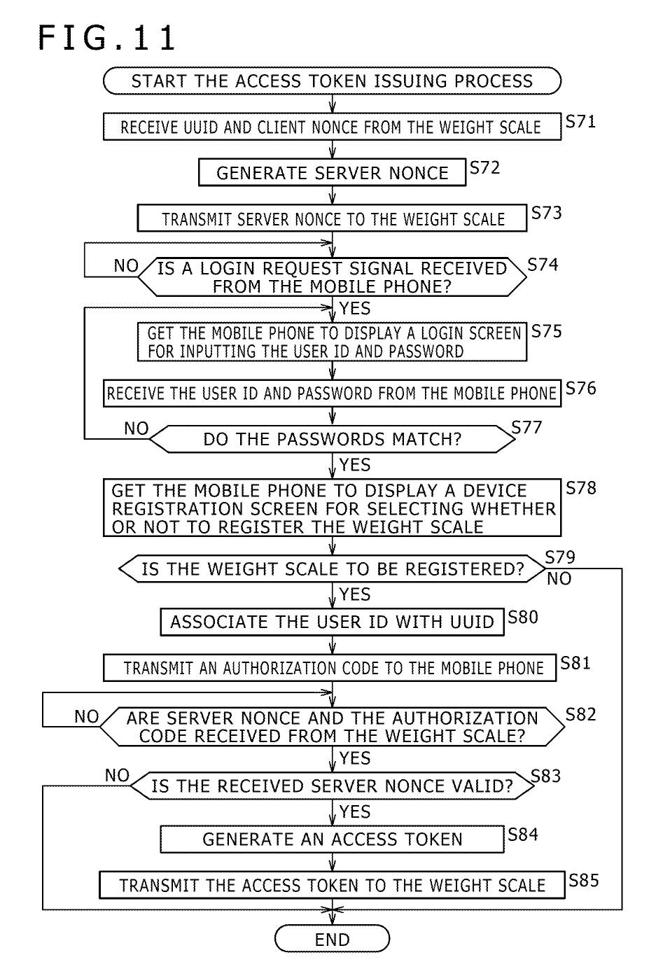

When the mobile phone 21 has performed the registration stand-in process to register the weight scale 22, the service offering server 25 carries out an access token issuing process to issue an access token to be supplied to the weight scale 22. The service offering server 25 will be discussed later in more detail by reference to FIGS. 10 and 11.

### [Outline of the Processing of the Transmission/Reception System 1]

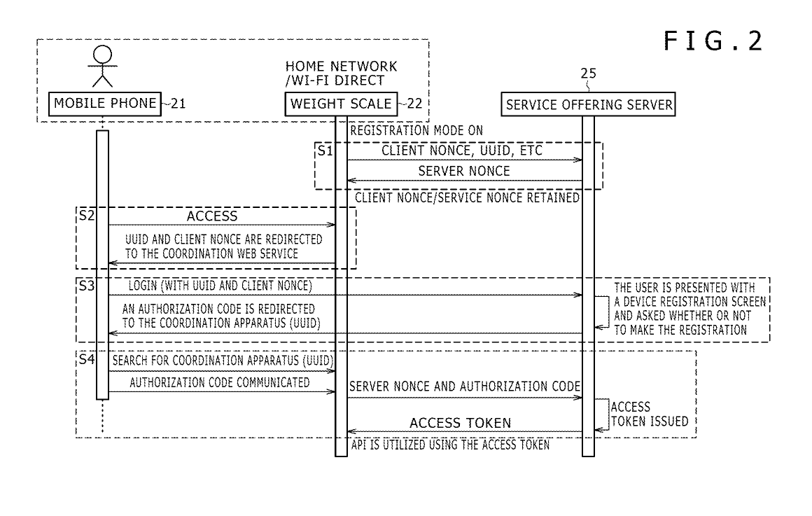

FIG. 2 outlines processes performed by the transmission/reception system 1.

In step S1, when a register button 81 (FIG. 8, to be discussed later) mounted on the weight scale 22 is pressed, the weight scale 22 generates and retains a random character string (called the client nonce hereunder). The weight scale 22 transmits the generated client nonce and device identification information uniquely identifying the weight scale 22 (called the uuid hereunder) to the service offering server 25 via the router 23 and network 24.

Upon acquisition (i.e., receipt) of the client nonce and uuid from the weight scale 22, the service offering server 25 supplies (transmits) a random character string (called the server nonce hereunder) to the weight scale 22 via the network 24 and router 23. The server nonce may be generated typically by the service offering server 25.

Incidentally, it is preferred that the uuid, client nonce, and server nonce be encrypted using HTTPS (hypertext transfer protocol over secure socket layer), symmetric key cryptography, public key cryptography or the like for secure communication.

The weight scale 22 receives and retains the server nonce supplied from the service offering server 25. The service offering server 25 retains the client nonce and uuid acquired from the weight scale 22 as well as the server nonce generated internally.

In step S2, upon accessing the weight scale 22 via the router 23, the mobile phone 21 acquires (receives) a first redirect designation signal furnished with the uuid and client nonce from the weight scale 22 via the router 23.

The first redirect designation signal is a signal that designates redirection (transmission) of the uuid and client nonce attached to the signal to the service offering server 25.

Besides communicating with the weight scale 22 via the router 23, the mobile phone 21 can communicate directly with the weight scale 22 using a wireless communication setup such as Wi-Fi Direct.

In step S3, upon acquisition of the first redirect designation signal from the weight scale 22, the mobile phone 21 transmits to the service offering server 25 a login request signal requesting a login to the service offering server 25 along with the uuid and client nonce.

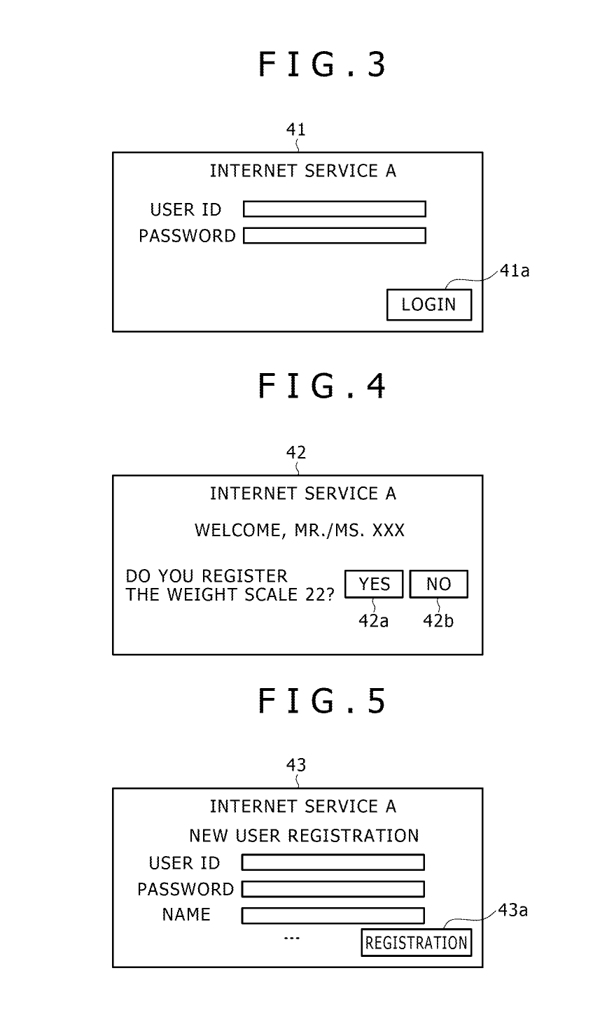

Given the login request signal from the mobile phone 21, the service offering server 25 transmits to the mobile phone 21 a login screen 41 (i.e., the data making up the screen) such as one shown in FIG. 3.

The mobile phone 21 displays the login screen 41 from the service offering server 25. When the user of the mobile phone 21 has input a user ID and a password into the login screen 41 and has pressed a login button 41a, the mobile phone 21 transmits the input user ID and password to the service offering server 25 via the router 23 and network 24.

Given the user ID and password from the mobile phone 21, the service offering server 25 allows the mobile phone 21 to log in. At this point, the service offering server 25 determines whether the uuid and client nonce acquired from the weight scale 22 in step S1 match the uuid and client nonce communicated from the mobile phone 21.

If the determination above results in a mismatch, the service offering server 25 transmits the result of the determination to the mobile phone 21 via the network 24 and router 23, and terminates the processing.

If the determination above results in a match, the service offering server 25 transmits to the mobile phone 21 a device registration screen 42 (i.e., the data making up the screen) such as one shown in FIG. 4. The device registration screen 42 displays an indication “WELCOME, MR./MS. XXX” naming the user identified by the user ID. The device registration screen 42 also displays the weight scale 22 corresponding to the uuid as the target to be registered.

For its part, the mobile phone 21 displays the device registration screen 42 from the service offering server 25. When the user of the mobile phone 21 has pressed a “YES” button 42a on the device registration screen 42, the mobile phone 21 transmits the affirmative response to the service offering server 25 via the router 23 and network 24.

Upon receipt of the affirmative response (representing the “YES” button 42a having been pressed) from the mobile phone 21, the service offering server 25 registers the weight scale 22 as a coordination apparatus offering services in coordination with the service offering server 25.

For example, when implementing the service to be offered to the user identified by the user ID, the service offering server 25 retains, in association with the user ID, the uuid of the weight scale 22 as the device identification information identifying the coordination apparatus offering the service in coordination with the service offering server 25.

Following the registration, the weight scale 22 is authorized as the coordination apparatus offering services in coordination with the service offering server 25. Using the mobile phone 21, the user can then receive the service offered by the service offering server 25 in coordination with the weight scale 22.

Thereafter, the service offering server 25 generates an authorization code indicating that the coordination of the weight scale 22 is possible when the service offering server 25 offers its service. The service offering server 25 transmits to the mobile phone 21 a second redirect designation signal furnished with the uuid and authorization code.

The second redirect designation signal is a signal that designates redirection (transmission) of the authorization code attached to the second redirect designation signal to the weight scale 22 identified by the uuid also accompanying the second redirect designation signal.

For example, if the user of the mobile phone 21 presses a “NO” button 42b on the device registration screen 42, the mobile phone 21 transmits the negative response to the service offering server 25 via the router 23 and network 24. Upon receipt of the response (representing the “NO” button 42b having been pressed) from the mobile phone 21, the service offering server 25 terminates the processing without associating the user ID with the uuid.

In step S4, upon receipt of the second redirect designation signal from the service offering server 25, the mobile phone 21 searches for the weight scale 22 based on the uuid attached to the second redirect designation signal, the search being made using UPnP (Universal Plug and Play), mDNS (multicast DNS) or like protocol. Under UPnP for example, M-SEARCH may be used.

As mentioned above, the mobile phone 21, weight scale 22, and router 23 constitute a home network.

The mobile phone 21, weight scale 22, and router 23 making up the home network are each identified in the home network by a private IP (internet protocol) address assigned thereto by a DHCP (dynamic host configuration protocol) server, not shown. Alternatively, the mobile phone 21, weight scale 22, and router 23 may each be assigned a private IP address by AutoIP.

Thus the mobile phone 21 can search for the weight scale 22 based on the private IP address assigned to that weight scale 22.

However, when a new electrical appliance is added to the home network, it might happen that the mobile phone 21, weight scale 22, and router 23 are each assigned a new, different private IP address by the DHCP server.

Also, the DHCP server cannot assign any FQDN (fully qualified domain name) to prevent changes of the IP addresses assigned to the mobile phone 21, weight scale 22, and router 23.

For that reason, the mobile phone 21 may not be able to find the weight scale 22 based on the private IP address thereof.

To avoid such an eventuality, the mobile phone 21 searches for the weight scale 22 based on the uuid that remains unchanged after being fixed by the DHCP server.

The mobile phone 21 communicates the authorization code accompanying the second redirect designation signal from the service offering server 25 to the weight scale 22 detected through the search.

Upon acquisition of the authorization code from the mobile phone 21, the weight scale 22 transmits to the service offering server 25 the acquired authorization code and the server nonce received in step S1 from the service offering server 25 and retained.

The service offering server 25 determines whether the server nonce and authorization code from the weight scale 22 match the server nonce and authorization code retained inside. If this determination results in a match, the service offering server 25 generates (issues) an access token and supplies it to the weight scale 22 via the network 24 and router 23.

The access token refers to the information needed by the weight scale 22 to execute the API of the service offering server 25.

Based on the access token supplied from the service offering server 25, the weight scale 22 can execute the API of the service offering server 25.

The foregoing paragraphs have outlined the processes carried out by the mobile phone 21, weight scale 22, and service offering server 25.

Even if the mobile phone 21 has not registered with the service offering server 25 the user ID and password for login to the server 25, the mobile phone 21 can register the user ID and password with the service offering server 25 upon gaining access to the server 25 in step S3.

For example, the service offering server 25 generates a new user registration screen 43 such as one shown in FIG. 5 and transmits the generated screen to the mobile phone 21 via the network 24 and router 23.

In turn, the mobile phone 21 displays the new user registration screen 43 received from the service offering server 25. The user enters the user registration information (e.g., user ID, password, user name, etc.) to be registered with the service offering server 25 into the new user registration screen 43, and presses a register button 43a.

Pressing the register button 43a causes the mobile phone 21 to transmit the user registration information to the service offering server 25 via the router 23 and network 24. The service offering server 25 retains the user registration information received from the mobile phone 21.

Thereafter, the mobile phone 21 can log in to the service offering server 25 in the manner discussed above in reference to step S3.

Where the system is configured as explained above, once the user registration information is registered with the service offering server 25 in step S3, the service offering server 25 can be logged in. The user can thus save a lot of trouble when registering the weight scale 22.

### [Typical Configuration of the Mobile Phone 21]

FIG. 6 shows a typical configuration of the mobile phone 21.

The mobile phone 21 is made up of an operation part 61, a control part 62, a communication part 63, a display part 64, and a storage part 65.

The operation part 61 is typically composed of operation buttons and other controls and is operated by the user upon input of the user ID, password, etc. The operation part 61 supplies the control part 62 with operation signals reflecting the user's operations.

The control part 62 controls the communication part 63, display part 64, and storage part 65, for example.

The communication part 63 acquires data supplied from the weight scale 22 via the router 23, and feeds the acquired data to the control part 62. Also, the communication part 63 receives data transmitted from the service offering server 25 via the network 24 and router 23, and supplies the received data to the control part 62.

The communication part 63 further supplies the data from the control part 62 to the weight scale 22 via the router 23. Also, the communication part 63 transmits the data from the control part 62 to the service offering server 25 via the router 23 and network 24.

The display part 64 displays images coming from the control part 62.

The storage part 65 stores (retains) the user ID identifying the user of the mobile phone 21. The storage part 65 also stores the data from the control part 62. Furthermore, programs and the like to be carried out by the control part 62 are stored beforehand in the storage part 65.

### [Explanation of the Operations of the Mobile Phone 21]

A registration stand-in process performed by the mobile phone 21 is explained below by reference to the flowchart of FIG. 7.

The registration stand-in process is started when the user operates the operation part 62 to gain access to the weight scale 22, for example. At this point, the operation part 61 supplies an operation signal reflecting the access operation to the control part 62.

In step S21, in response to the operation signal from the operation part 61, the control part 62 controls the communication part 63 to access the weight scale 22 via the router 23. With the weight scale 22 accessed, the control part 62 acquires a first redirect designation signal furnished with a uuid and a client nonce from the weight scale 22 via the router 23 and communication part 63.

In step S22, the control part 62 extracts the uuid and client nonce from the acquired first redirect designation signal, generates a login request signal furnished with the extracted uuid and client nonce, and supplies the login request signal thus generated to the communication part 63. The control part 62 controls the communication part 63 to transmit the login request signal to the service offering server 25 via the router 23 and network 24.

Based on the login request signal received from the communication part 62, the service offering server 25 transmits the login screen 41 to the communication part 63 via the network 24 and router 23.

The service offering server 25 determines whether the uuid and client nonce received along with the login request signal match the uuid and client nonce acquired previously from the weight scale 22. If this determination results in a match, the service offering server 25 recognizes the weight scale 22 as the target to be registered.

In step S23, the control part 62 controls the communication part 63 to receive the login screen 41 from the service offering server 25 and to supply the received screen to the display part 64 so as to display the login screen 41 on the latter.

In step S24, given the operation signal from the operation part 61, the control part 62 determines whether the login button 41a is pressed on the login screen 41. The control part 62 repeats the processing of step S24 until it is determined that the login button 41a is pressed.

If in step S24 the control part 62 determines, based on the operation signal from the operation part 61, that the login button 41a is pressed on the login screen 41, the control part 62 passes control to step S25.

In step S25, the control part 62 supplies the communication part 63 with the user ID and password input through the login screen 41. Then the control part 62 controls the communication part 63 to transmit the user ID and password to the service offering server 25 via the router 23 and network 24.

In turn, the service offering server 25 determines whether or not to authorize the mobile phone 21 to log in based on whether the user ID and password received from the mobile phone 21 match the previously registered user ID and password. If the determination leads to a rejection of login authorization based on a mismatch, the service offering server 25 generates login rejection information indicative of the rejection of login authorization, and transmits the generated information to the communication part 63 via the network 24 and router 23.

If the determination above results in permission to grant login authorization based on a match, the service offering server 25 generates the device registration screen 42 for prompting the user to select whether or not to register the weight scale 22, and transmits the generated screen 42 to the communication part 63 via the network 24 and router 23.

If the service offering server 25 determines that the extracted uuid and client nonce do not match the previously acquired uuid and client nonce from the weight scale 22, then the device registration screen 42 is not generated.

In step S26, the control part 62 controls the communication part 63 to determine whether the login rejection information is received from the service offering server 25. Upon receipt of the login rejection information, the control part 62 determines that the attempt to log in to the service offering server 25 has failed, returns control to step S23, and repeats the subsequent steps.

If in step S26 the control part 62 controls the communication part 63 to find out that the device registration screen 42 is received from the service offering server 25, the control part 62 determines that a login to the service offering server 25 is authorized, and passes control to step S27.

In step S27, the control part 62 supplies the received device registration screen 42 to the display part 64 and causes the display part 64 to display the screen 42.

In step S28, based on the operation signal from the operation part 61, the control part 62 determines whether the “YES” button 42a or “NO” button 42b is pressed on the device registration screen 42 displayed on the display part 64. The control part 62 repeats the processing of step S28 until it is determined that either the “YES” button 42a or the “NO” button 42b is pressed.

If in step S28 the control part 62 determines, based on the operation signal from the operation part 61, that the “NO” button 42b is pressed, then the control part 62 terminates the registration stand-in process.

If in step S28 the control part 62 determines, based on the operation signal from the operation part 61, that the “YES” button 42a is pressed, the control part 62 generates registration request information requesting that the weight scale 22 be registered and supplies the generated information to the communication part 63. The control part 62 then controls the communication part 63 to transmit the generated registration request information to the service offering server 25 via the router 23 and network 24. After step S28, the control part 62 passes control to step S29.

In response to the registration request information received from the communication part 63, the service offering server 25 retains the uuid of the weight scale 22 in association with the user ID and thereby authorizes the weight scale 22 to become a coordination apparatus for use in coordination with the service offering server 25. The service offering server 25 proceeds to generate a second redirect designation signal furnished with the uuid and an authorization code authorizing the coordination of the weight scale 22 upon offering of the service. The service offering server 25 transmits the second redirect designation signal thus generated to the communication part 63 via the network 24 and router 23.

In step S29, the control part 62 controls the communication part 63 to receive the second redirect designation signal from the service offering server 25.

In step S30, the control part 62 controls the communication part 63 to search for the weight scale 22 based on the uuid attached to the received second redirect designation signal. The control part 62 proceeds to establish connection with the weight scale 22 recognized through the search.

In step S31, the control part 62 controls the communication part 63 to communicate to the weight scale 22 the authorization code attached to the received second redirect designation signal. This step completes the registration stand-in process.

Where the registration stand-in process is carried out as explained above, the mobile phone 21 can stand in for the weight scale 22 to log in to the service offering server 25 and to transmit the uuid and client nonce acquired from the weight scale 22 to the service offering server 25.

Thus upon login to the service offering server 25, it is possible to register with the service offering server 25 the weight scale 22 that has neither an operation part for inputting a user ID and password nor a display part for displaying the user ID or password (or some other electrical appliance or the like lacking an adequate operation part or display part), as a coordination apparatus, for example.

Also where the registration stand-in process is carried out, the user of the mobile phone 21 can register the weight scale 22 through simple input operations involving the input of the user ID and password.

Furthermore, with a session being held by a browser on the mobile phone 21 for example, if the service offering server 25 has already been logged in, the mobile phone 21 can register the weight scale 22 without operations for inputting the user ID and password.

Thus the user can receive the service from the service offering server 25 in coordination with the weight scale 22 or the like based on simple settings using the mobile phone 21.

Where the registration stand-in process is carried out, the user ID and password are input to the mobile phone 21 before being transmitted to the service offering server 25. That means there is no need for the weight scale 22 to manage the user ID and password.

It follows that during manufacture of the weight scale 22, it is not necessary to implement countermeasures against cracking on the weight scale 22. This alleviates the burden in the implementation of the weight scale 22.

Also, because there is no worry that the user ID and password may be stolen from the weight scale 22, the mobile phone 21 can use the service from the service offering server 25 more securely than ever.

Furthermore, since it is not necessary for the weight scale 22 to manage the user ID and password, if the password registered with the service offering server 25 is to be changed, there is no need to change the password managed by the weight scale 22, unlike the case in which the password is managed by the weight scale 22.

As a result, the user can change the password registered with the service offering server 25 more easily than if the password were managed by the weight scale 22. This can provide a significant improvement in security.

### [Typical Configuration of the Weight Scale 22]

FIG. 8 shows a typical configuration of the weight scale 22.

The weight scale 22 is made up of a register button 81, a control part 82, a communication part 83, a display part 84, and a storage part 85.

The register button 81 is a button that is operated to register the weight scale 22 with the service offering server 25. For example, when pressed by the user, the register button 81 supplies the control part 82 with an operation signal reflecting the user's pressing operation.

The control part 82 controls the communication part 83, display part 84, and storage part 85, for example. The control part 82 measures the user's weight typically when the user steps on the weight scale 22, and supplies the result of the measurement to the display part 84 for display thereon.

The communication part 83 acquires data supplied from the mobile phone 21 via the router 23 and supplies the acquired data to the control part 82. Also, the communication part 83 receives data transmitted from the service offering server 25 via the network 24 and router 23 and supplies the received data to the control part 82.

Furthermore, the communication part 83 supplies the mobile phone 21 with the data from the control part 82 via the router 23. The communication part 83 also transmits the data from the control part 82 to the service offering server 25 via the router 23 and network 24.

Under control of the control part 82, for example, the display part 84 displays the result of measuring the user's weight.

The storage part 85 typically retains (stores) beforehand the uuid of the weight scale 22. The storage part 85 also stores the data from the control part 82. The storage part 85 further stores beforehand the programs and the like to be carried out by the control part 82.

### [Explanation of the Operations of the Weight Scale 22]

An access token acquisition process to be performed by the weight scale 22 is explained below by reference to the flowchart of FIG. 9.

The access token acquisition process is started when the user presses the register button 81 of the weight scale 22, for example. At this point, the register button 81 supplies the control part 82 with an operation signal reflecting the user's pressing operation.

In step S51, in response to the operation signal from the register button 81, the control part 82 generates a client nonce. In step S52, the control part 82 retrieves the uuid retained previously in the storage part 85.

In step S53, the control part 82 supplies the generated client nonce and the retrieved uuid to the communication part 83. The control part 82 then controls the communication part 83 to transmit the client nonce and uuid to the service offering server 25 via the router 23 and network 24.

In turn, upon acquisition (receipt) of the uuid and client nonce from the weight scale 22, the service offering server 25 supplies (transmits) a server nonce to the communication part 83 via the network 24 and router 23. The server nonce represents a random character string generated by the service offering server 25.

In step S54, the control part 82 controls the communication part 83 to receive the server nonce from the service offering server 25. After step S54, the control part 82 passes control to step S55.

In step S55, the control part 82 controls the communication part 83 to determine whether the mobile phone 21 has accessed the communication part 83. The control part 82 repeats the processing of step S55 until it is determined that the mobile phone has accessed the communication part 83.

If the control part 82 determines through control over the communication part 83 that the mobile phone 21 has accessed the communication part 83, the control part 82 passes control to step S56.

In step S56, the control part 82 generates a first redirect designation signal furnished with the client nonce generated in step S51 and with the uuid retrieved in step S52, and supplies the generated signal to the communication part 83. The control part 82 then controls the communication part 83 to supply the generated first redirect designation signal to the mobile phone 21 via the router 23.

In turn, upon acquisition of the first redirect designation signal from the communication part 83 of the weight scale 22, the mobile phone 21 logs in to the service offering server 25, and transmits the uuid and client nonce accompanying the first redirect designation signal to the server 25.

When the service offering server 25 has registered the weight scale 22 based on the uuid and client nonce from the mobile phone 21, the service offering server 25 transmits an authorization code and the uuid to the mobile phone 21 via the network 24 and router 23.

The mobile phone 21 communicates the authorization code from the service offering server 25 to the weight scale 22 identified by the uuid also from the service offering server 25.

In step S57, the control part 82 controls the communication part 83 to determine whether the mobile phone 21 has communicated the authorization code to the communication part 83 via the router 23. The control part 82 repeats the processing of step S57 until it is determined that the authorization code is communicated to the communication part 83.

When in step S57 the control part 82 determines through control over the communication part 83 that the mobile phone 21 has communicated the authorization code to the communication part 83 via the router 23, the control part 82 passes control to step S58.

In step S58, the control part 82 supplies the communication part 83 with the authorization code communicated from the mobile phone 21 via the router 23 and with the client nonce received in step S54. The control part 82 then controls the communication part 83 to transmit the authorization code and client nonce to the service offering server 25 via the router 23 and network 24.

Incidentally, the service offering server 25 retains the client nonce transmitted in step S53 as well as the authorization code already transmitted to the mobile phone 21.

The service offering server 25 determines whether the authorization code and client nonce acquired (received) from the communication part 83 of the weight scale 22 match the authorization code and client nonce retained in advance. If this determination results in a match, the service offering server 25 generates an access token and supplies it to the communication part 83 via the network 24 and router 23.

In step S59, the control part 82 controls the communication part 83 to receive the access token from the service offering server 25. This step completes the access token acquisition process.

Where the access token acquisition process is carried out as explained above, the mobile phone 21 is supplied with the uuid and client nonce of the weight scale 22 so that the mobile phone 21, equipped with the display part 64 for displaying the login screen 41 and the operation part 61 for inputting the user ID and password, may register the weight scale 22.

Thus even if the weight scale 22 is not furnished with a display part for displaying the login screen 41 or an operation part for inputting the user ID and password, it is possible to register the weight scale 22 with the service offering server 25.

Because it is not necessary for the weight scale 22 to manage a user ID or a password, there is no worry that the user ID and password may be stolen from the weight scale 22. Thus the service can be utilized securely.

### [Typical Configuration of the Service Offering Server 25]

FIG. 10 shows a typical configuration of the service offering server 25.

The service offering server 25 is made up of a communication part 101, a control part 102, and a storage part 103.

The communication part 101 receives data transmitted from the mobile phone 21 via the router 23 and network 24, and supplies the received data to the control part 102. Also, the communication part 101 transmits the data from the control part 102 to the mobile phone 21 via the network 24 and router 23.

Furthermore, the communication part 101 receives data transmitted from the weight scale 22 via the router 23 and network 24, and supplies the received data to the control part 102. The communication part 101 also supplies the data from the control part 102 to the weight scale 22 via the network 24 and router 23.

The control part 102 controls the communication part 101 and storage part 103, for example.

The storage part 103 stores (retains) the data from the control part 102. The storage part 103 also retains beforehand the programs and the like to be carried out by the control part 102.

### [Explanation of the Operations of the Service Offering Server 25]

An access token issuing process to be performed by the service offering server 25 is explained below by reference to the flowchart of FIG. 11.

The access token issuing process is started when the weight scale 22 transmits its uuid and client nonce to the server 25 via the router 23 and network 24, for example.

In step S71, the control part 102 controls the communication part 101 to acquire the uuid and client nonce transmitted from the weight scale 22, and supplies the acquired uuid and client nonce to the storage part 103 for storage (retention) therein.

In step S72, the control part 102 generates a server nonce and supplies it to the communication part 101. Alternatively, the control part 102 may generate the server nonce not in step S72 but prior to step S71.

In step S73, the control part 102 controls the communication part 101 to supply the generated server nonce to the weight scale 22 via the network 24 and router 23. This step allows the weight scale 22 to retain the server nonce coming from the communication part 101 of the service offering server 25.

In step S74, the control part 102 controls the communication part 101 to determine whether a login request signal is received from the mobile phone 21 together with the uuid and client nonce. The control part 102 repeats the processing of step S74 until it is determined that the login request signal is received.

When in step S74 the control part 102 determines through control over the communication part 101 that the login request signal is received from the mobile phone 21 along with the uuid and client nonce, the control part 102 passes control to step S75.

In step S75, the control part 102 generates the login screen 41 such as one shown in FIG. 3 and supplies the generated screen to the communication part 101. The control part 102 then controls the communication part 101 to transmit the generated login screen 41 to the mobile phone 21 via the network 24 and router 23.

In this manner, the mobile phone 21 displays the login screen 41 from the communication part 101 of the service offering server 25.

The mobile phone 21 transmits to the communication part 101 the user ID and password entered into the login screen 41, via the router 23 and network 24.

In turn, the control part 102 in step S76 controls the communication part 101 to receive the user ID and password from the mobile phone 21. After step S76, the control part 102 passes control to step S77.

In step S77, from among the passwords corresponding to the user IDs retained beforehand in the storage part 103, the control part 102 retrieves the password corresponding to the received user ID. The control part 102 then determines whether the retrieved password matches the received password.

If in step S77 the control part 102 determines that the retrieved password does not match the received password, the control part 102 returns control to step S75 and repeats the subsequent steps.

If it is determined in step S77 that the received user ID is not retained in the storage part 103 for example, the control part 102 generates the new user registration screen 43 such as one shown in FIG. 5, and transmits the generated screen to the mobile phone 21 via the network 24 and router 23. After the mobile phone 21 has registered the user ID and password with the service offering server 25, the control part 102 returns control to step S75 and repeats the subsequent steps.

If it is determined in step S77 that the retrieved password matches the received password, the control part 102 passes control to step S78.

In step S78, the control part 102 determines whether the uuid and client nonce received already in step S74 from the mobile phone 21 along with the login request signal match the uuid and client nonce acquired previously in step S71 from the weight scale 22.

If the determination above results in a match, the control part 102 generates the device registration screen 42 such as one shown in FIG. 4, and supplies the generated screen to the communication part 101. The control part 102 controls the communication part 101 to transmit the generated device registration screen 42 to the mobile phone 21 via the network 24 and router 23.

In turn, the mobile phone 21 has its display part 64 display the device registration screen 42 received from the communication part 101 of the service offering server 25.

When the “YES” button 42a is pressed on the device registration screen 42, the mobile phone 21 generates registration request information and transmits the generated information to the communication part 101 via the router 23 and network 24.

In step S79, the control part 102 determines through control over the communication part 101 whether or not to register the weight scale 22 based on whether the registration request information is received from the mobile phone 21. For example, if it is determined that the registration request information is not received from the mobile phone 21 within a predetermined time period, the control part 102 concludes that the weight scale 22 is not to be registered, and terminates the access token issuing process.

If it is determined in step S79 that the registration request information is received from the mobile phone 21 within the predetermined time period, the control part 102 concludes that the weight scale 22 is to be registered. In this case, the control part 102 passes control to step S80.

In step S80, the control part 102 stores into the storage part 103 the user ID in association with the uuid of the weight scale 22. This step authorizes the weight scale 22 to operate in coordination with the service offering server 25 upon offering of the service.

In step S81, the control part 102 retrieves the uuid retained in the storage part 103. Also, the control part 102 generates an authorization code, generates a second redirect designation signal furnished with the generated authorization code and the retrieved uuid, and supplies the generated signal to the communication part 101.

The control part 102 then controls the communication part 101 to transmit the generated second redirect designation signal to the mobile phone 21 via the network 24 and router 23.

In turn, based on the second redirect designation signal from the communication part 101, the mobile phone 21 communicates the authorization code attached to the second redirect designation signal to the weight scale 22 identified by the uuid also attached to the second redirect designation signal.

It is assumed here that the weight scale 22 received the server nonce transmitted in step S73 from the service offering server 25 and retains the server nonce thus received.

The weight scale 22 acquires the authorization code communicated from the mobile phone 21. The weight scale 22 then transmits the retained server nonce and the acquired authorization code to the communication part 101 via the router 23 and network 24.

In step S82, the control part 102 controls the communication part 101 to determine whether the server nonce and authorization code are acquired (received) from the weight scale 22. The control part 102 repeats the processing of step S82 until it is determined that the server nonce and authorization code are acquired.

If in step S82 the control part 102 determines through control over the communication part 101 that the server nonce and authorization code are acquired from the weight scale 22, the control part 102 passes control to step S83.

In step S83, the control part 102 determines whether the server nonce and authorization code received from the weight scale 22 are valid.

For example, the control part 102 determines whether the authorization code and server nonce already retained in the storage part 103 match the authorization code and sever nonce received from the weight scale 22. If this determination results in a mismatch, the control part 102 concludes that the server nonce and authorization code received from the weight scale 22 are not valid, and terminates the access token issuing process.

If in step S83 the control part 102 determines that the authorization code and server nonce retained in the storage part 103 match the authorization code and server nonce received from the weight scale 22, the control part 102 concludes that the server nonce and authorization code received from the weight scale 22 are valid, and passes control to step S84.

In step S84, the control part 102 issues (generates) a minimum of the access token necessary for executing the API for the weight scale 22 and supplies the issued access token to the communication part 101. In step S85, the control part 102 controls the communication part 101 to supply (transmit) the generated access token to the weight scale 22 via the network 24 and router 23. This step completes the access token issuing process.

Where the access token issuing process is carried out as explained above, what is issued is a minimum of the access token necessary for executing the API (e.g., an access token sufficient for the weight scale 22 to access only the API for the weight scale 22). Thus even if the access token is stolen and abused, the damage can be limited to a minimum.

If the user becomes aware of the access token being stolen, the stolen access token may be invalidated in order to forestall the damage that could be caused by the theft.

The service offering server 25 may then issue and distribute a new access token to replace the invalidated access token. This makes it possible securely to implement the services that are offered to the user.

Also where the access token issuing process is carried out, if the control part 102 determines in step S78 that the uuid and client nonce received previously in step S74 match the uuid and client nonce acquired previously in step S71, the control part 102 generates the device registration screen 42 and causes the communication part 101 to transmit the generated screen to the mobile phone 21 as described.

Thus even if some communication apparatus other than the mobile phone 21 has illicitly acquired the uuid of the weight scale 22, the communication apparatus not supplied with the client nonce from the weight scale 22 cannot receive the device registration screen 42 from the service offering server 25.

For that reason, it is possible to prevent the communication apparatus other than the mobile phone 21 from illicitly registering the weight scale 22.

Furthermore, where the access token issuing process is carried out, the control part 102 in step S73 controls the communication part 101 to supply the generated server nonce to the weight scale 22 so that the weight scale 22 may retain the server nonce, as explained.

Also, the control part 102 in step S83 determines whether the authorization code and server nonce retained previously in the storage part 103 match the authorization code and sever nonce received from the weight scale 22. When this determination results in a match, the control part 102 in step S84 issues the access token and sends it to the weight scale 22.

Thus even if a coordination apparatus other than the weight scale 22 has illicitly acquired the authorization code of the weight scale 22, the coordination apparatus in question is not supplied with the server nonce from the service offering server 25. This prevents the unscrupulous coordination apparatus from illicitly obtaining the access token.

### 2. Variations

In the above-described embodiment, the weight scale 22 was shown to offer the service determined in advance by its manufacturer or the like in coordination with the service offering server 25.

However, in addition to the predetermined service, the weight scale 22 may further offer, in coordination with the service offering server 25, services prepared by the user of the weight scale 22 or services provided by companies other than the weight scale manufacturer.

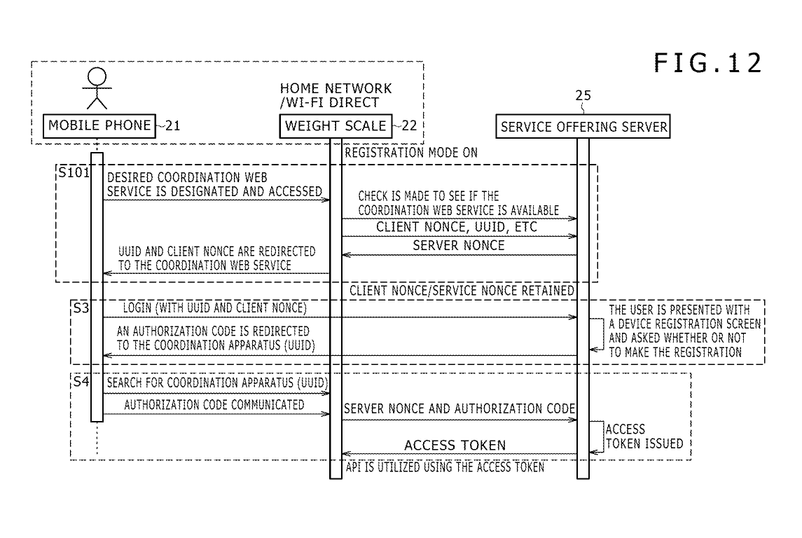

FIG. 12 is an explanatory view outlining other processes performed by the transmission/reception system 1 when the weight scale 22 offers other services in coordination with the service offering server 25.

Of the processes in FIG. 12, those also shown in FIG. 2 will not be explained further hereunder.

Specifically, the processes in FIG. 12 are substantially the same as those in FIG. 2 except that a new step S101 in FIG. 12 replaces steps S1 and S2 in FIG. 2.

In step S101, in response to the user's operations designating one of a plurality of available services, the mobile phone 21 transmits designated service information indicative of the designated service to the weight scale 22 via the router 23.

Upon acquisition of the designated service information from the mobile phone 21, the weight scale 22 transmits its uuid and the designated service information to the service offering server 25 via the router 23 and network 24, the service offering server 25 offering the service indicated by the designated service information acquired.

In turn, based on the uuid received from the weight scale 22, the service offering server 25 determines whether the coordination of the weight scale 22 is possible upon offering of the service indicated by the designated service information also received from the weight scale 22. The service offering server 25 supplies the result of this determination to the weight scale 22 via the network 24 and router 23.

On receiving the result of the determination indicating that the coordination of the weight scale 22 is possible upon offering of the service designated by the user, the weight scale 22 starts the access token acquisition process.

That is, in the above-described embodiment, pressing the register button 81 of the weight scale 22 was shown to trigger the start of the access token acquisition process by the weight scale 22. In the setup explained by reference to FIG. 12, by contrast, the execution of the access token acquisition process by the weight scale 22 is triggered by receipt of the result of the determination from the service offering server 25 indicating that the coordination of the weight scale 22 is possible upon offering of the service designated by the user.

The setup explained by reference to FIG. 12 allows the user to utilize desired services that may be designated by the user. This feature widens the scope of the services that are made available to the user.

Through the use of the mobile phone 21, the user can thus utilize service offering servers that offer reasonably priced services, service offering servers that are trustworthy, and service offering servers that operate at high communication speeds.

In the above-described embodiment, the mobile phone 21 was shown to stand in for the weight scale 22 to register the weight scale 22 with the service offering server 25. However, the target that can be registered is not limited to the weight scale 22; any electrical appliance may be registered as long as it can form part of the home network. For example, the targets that can be registered include thermometers, hygrometers, air conditioners, refrigerators, washing machines, microwave ovens, treadmills, massage chairs, TV sets, and recorders.

In the above-described embodiment, only the weight scale 22 was shown to be registered. Alternatively, where a plurality of electrical appliances make up the home network, two or more electrical appliances can be registered for the same service offered by the service offering apparatus 25.

In the above-described embodiment, the mobile phone 21 was shown to stand in for the weight scale 22 to make the registration. However, the apparatus that can stand in for the weight scale 22 is not limited to the mobile phone 21. Any other apparatus may serve the purpose as long as it allows the user ID and password to be entered.

For example, a TV set or the like with its remote controller capable of inputting the user ID and password may be used in place of the mobile phone 21.

The technology of the present disclosure may also be configured as follows:

[1] A communication apparatus including:

an input part configured to input user identification information identifying a user ready to receive a service offered by a service offering apparatus via a network;

an acquisition part configured to acquire device identification information from a coordination apparatus capable of offering the service in coordination with the service offering apparatus, the device identification information identifying the coordination apparatus;

a transmission part configured to transmit to the service offering apparatus the user identification information input by the input part and the device identification information acquired by the acquisition part;

a reception part configured to receive from the service offering apparatus authorization information indicating that the coordination of the coordination apparatus is authorized upon offering of the service in response to the transmission of the user identification information and the device identification information; and

a notification part configured to notify the coordination apparatus of the authorization information received.

[2] The communication apparatus as described in paragraph [1] above, in which the notification part communicates the received authorization information to the coordination apparatus identified by the device identification information that is fixed.

[3] The communication apparatus as described in paragraph [1] or [2] above, in which

the acquisition part acquires from the coordination apparatus the device identification information along with coordination side-generated information generated by the coordination apparatus, and

the transmission part transmits to the service offering apparatus the user identification information input by the input part, as well as the device identification information and the coordination side-generated information acquired by the acquisition part.

[4] The communication apparatus as described in any one of paragraphs [1] through [3] above, further including a supply part configured to supply the coordination apparatus with designated service information indicative of one of a plurality of services which is designated by the user;

in which the acquisition part acquires the device identification information from the coordination apparatus capable of offering the service designated by the user in coordination with the service offering apparatus in response to the supply of the designated service information to the coordination apparatus.

[5] A communication method for use with a communication apparatus communicating user identification information identifying a user, the communication method including:

acquiring through the communication apparatus device identification information from a coordination apparatus capable of offering a service in coordination with a service offering apparatus offering the service via a network, the device identification information identifying the coordination apparatus;

transmitting to the service offering apparatus the user identification information input by an input part of the communication apparatus inputting the user identification information identifying the user ready to receive the service from the service offering apparatus, and the device identification information acquired;

receiving from the service offering apparatus authorization information indicating that the coordination of the coordination apparatus is authorized upon offering of the service in response to the transmission of the user identification information and the device identification information; and

notifying the coordination apparatus of the authorization information received.

[6] A program for causing a computer to function as an apparatus including:

an acquisition part configured to acquire device identification information from a coordination apparatus capable of offering a service in coordination with a service offering apparatus offering the service via a network, the device identification information identifying the coordination apparatus;

a transmission control part configured to transmit to the service offering apparatus the user identification information input by an input part of the communication apparatus inputting the user identification information identifying a user ready to receive the service from the service offering apparatus, and the device identification information acquired by the acquisition part;

a reception control part configured to receive from the service offering apparatus authorization information indicating that the coordination of the coordination apparatus is authorized upon offering of the service in response to the transmission of the user identification information and the device identification information; and

a notification control part configured to notify the coordination apparatus of the authorization information received.

[7] A service offering apparatus for offering a service via a network, the service offering apparatus including:

a reception part configured to receive device identification information and user identification information from a communication apparatus to which the user identification information identifying a user ready to receive the service is input and which is supplied with the device identification information identifying a coordination apparatus capable of offering the service in coordination with the service offering apparatus;

a storage control part configured to store the device identification information in association with the user identification information;

a transmission part configured to transmit to the communication apparatus authorization information indicating that the coordination of the coordination apparatus is authorized upon offering of the service in response to the storage of the device identification information in association with the user identification information;

an acquisition part configured to acquire from the coordination apparatus the authorization information received by the communication apparatus and communicated to the coordination apparatus; and

a supply part configured to supply the coordination apparatus with coordination use information to be used by the coordination apparatus upon offering of the service in accordance with the authorization information acquired.

[8] The service offering apparatus as described in paragraph [7] above, in which

the coordination apparatus generates coordination side-generated information indicative of a random character string,

the acquisition part acquires from the coordination apparatus the first coordination side-generation information and the first device identification information,

the reception part receives the second coordination side-generated information and the second device identification information from the communication apparatus to which the second coordination side-generated information is supplied by the coordination apparatus, and

upon coincidence between the acquired first coordination side-generated information and first device identification information on the one hand and the received second coordination side-generated information and second device identification information on the other hand, the storage control part stores the device identification information in association with the user identification information.

[9] The service offering apparatus as described in paragraph [7] or [8] above, further including:

a generation part configured to generate service side-generated information indicative of a random character string; and

another transmission part configured to transmit the first service side-generated information to the coordination apparatus;

in which the acquisition part acquires the first authorization information and the second service side-generated information from the coordination apparatus having received the second service side-generated information from the other transmission part, and

upon coincidence between the first service side-generated information and the second authorization information transmitted to the communication apparatus on the one hand and the second service side-generated information and the second authorization information on the other hand, the supply part supplies the coordination apparatus with the coordination use information.

[10] The service offering apparatus as described in paragraph [7] through [9] above, further including:

another reception part configured to receive from coordination apparatus the device identification information and designated service information indicative of the service designated by the user of the communication apparatus; and

a determination part configured to determine whether the coordination apparatus can coordinate when the service designated by the designated service information is offered, on the basis of the device identification information received from the coordination apparatus;

in which the supply part supplies the coordination apparatus with a result of the determination made by the determination part.

[11] A service offering method for use with a service offering apparatus offering a service via a network, the service offering method including:

receiving device identification information and user identification information from a communication apparatus to which the user identification information identifying a user ready to receive the service is input and which is supplied with the device identification information identifying a coordination apparatus capable of offering the service in coordination with the service offering apparatus;

performing control to store the device identification information in association with the user identification information;

transmitting to the communication apparatus authorization information indicating that the coordination of the coordination apparatus is authorized upon offering of the service in response to the storage of the device identification information in association with the user identification information;

acquiring from the coordination apparatus the authorization information received by the communication apparatus and communicated to the coordination apparatus; and

supplying the coordination apparatus with coordination use information to be used by the coordination apparatus upon offering of the service in accordance with the authorization information acquired.

[12] A program for causing a computer of a service offering apparatus offering a service via a network to function as an apparatus including:

a reception control part configured to receive device identification information and user identification information from a communication apparatus to which the user identification information identifying a user ready to receive the service is input and which is supplied with the device identification information identifying a coordination apparatus capable of offering the service in coordination with the service offering apparatus;

a storage control part configured to store the device identification information in association with the user identification information;

a transmission control part configured to transmit to the communication apparatus authorization information indicating that the coordination of the coordination apparatus is authorized upon offering of the service in response to the storage of the device identification information in association with the user identification information;

an acquisition control part configured to acquire from the coordination apparatus the authorization information received by the communication apparatus and communicated to the coordination apparatus; and

a supply control part configured to supply the coordination apparatus with coordination use information to be used by the coordination apparatus upon offering of the service in accordance with the authorization information acquired.

[13] A coordination apparatus capable of offering a service in coordination with a service offering apparatus offering the service via a network, the coordination apparatus including:

a supply part configured to supply device identification information identifying the coordination apparatus to a communication apparatus to which user identification information identifying a user ready to receive the service is input;

a transmission part configured to transmit to the service offering apparatus authorization information which is communicated from the communication apparatus and which indicates that the coordination of the coordination apparatus is authorized upon offering of the service; and

a reception part configured to receive from the service offering apparatus coordination use information to be used for coordination with the service offering apparatus in response to the transmission of the authorization information.

[14] The coordination apparatus as described in paragraph [13] above, in which

the reception part receives from the service offering apparatus service side-generated information generated by the service offering apparatus, and

the transmission part transmits to the service offering apparatus the authorization information communicated from the communication apparatus along with the service side-generated information received.

[15] The coordination apparatus as described in paragraph [13] or [14] above, in which

the transmission part transmits designated service information and the device identification information to the service offering apparatus offering the service designated by the designated service information received from the communication apparatus,

the reception part receives, from the service offering apparatus having received the designated service information and the device identification information, a result of the determination of whether the coordination of the coordination apparatus is possible on the basis of the designated service information and the device identification information, and

the supply part supplies the communication apparatus with the device identification information in response to the receipt of the result of the determination that the coordination of the coordination apparatus is possible.

[16] A coordination method for use with a coordination apparatus capable of offering a service in coordination with a service offering apparatus offering the service via a network, the coordination method including:

supplying device identification information identifying the coordination apparatus to a communication apparatus to which user identification information identifying a user ready to receive the service is input;

transmitting to the service offering apparatus authorization information which is communicated from the communication apparatus and which indicates that the coordination of the coordination apparatus is authorized upon offering of the service; and

receiving from the service offering apparatus coordination use information to be used for coordination with the service offering apparatus in response to the transmission of the authorization information.

[17] A program for causing a computer of a coordination apparatus capable of offering a service in coordination with a service offering apparatus offering the service via a network to function as an apparatus including:

a supply control part configured to supply device identification information identifying the coordination apparatus to a communication apparatus to which user identification information identifying a user ready to receive the service is input;

a transmission control part configured to transmit to the service offering apparatus authorization information which is communicated from the communication apparatus and which indicates that the coordination of the coordination apparatus is authorized upon offering of the service; and

a reception control part configured to receive from the service offering apparatus coordination use information to be used for coordination with the service offering apparatus in response to the transmission of the authorization information.

[18] A transmission/reception system including:

a communication apparatus communicating user identification information identifying a user;

a service offering apparatus offering a service to the user via a network; and

a coordination apparatus capable of coordinating with the service offering apparatus;

the communication apparatus including
an input part configured to input the user identification information identifying the user ready to receive the service offered by the service offering apparatus,
a first acquisition part configured to acquire device identification information from the coordination apparatus, the device identification information identifying the coordination apparatus,
a first transmission part configured to transmit to the service offering apparatus the user identification information input by the input part and the device identification information acquired by the first acquisition part,
a first reception part configured to receive from the service offering apparatus authorization information indicating that the coordination of the coordination apparatus is authorized upon offering of the service in response to the transmission of the user identification information and the device identification information, and
a notification part configured to notify the coordination apparatus of the authorization information received,

the service offering apparatus including
a second reception part configured to receive the device identification information and the user identification information from the communication apparatus,
a storage control part configured to store the device identification information in association with the user identification information,
a second transmission part configured to transmit to the communication apparatus the authorization information in response to the storage of the device identification information in association with the user identification information,
a second acquisition part configured to acquire from the coordination apparatus the authorization information received by the communication apparatus and communicated to the coordination apparatus, and
a first supply part configured to supply the coordination apparatus with coordination use information to be used by the coordination apparatus upon offering of the service in accordance with the authorization information acquired, and

the coordination apparatus including
a second supply part configured to supply the device identification information to the communication apparatus,
a third transmission part configured to transmit to the service offering apparatus the authorization information communicated from the communication apparatus, and
a third reception part configured to receive the coordination use information from the service offering apparatus in response to the transmission of the authorization information.

[19] A transmission/reception method for use with a transmission/reception system including a communication apparatus communicating user identification information identifying a user, a service offering apparatus offering a service to the user via a network, and a coordination apparatus capable of coordinating with the service offering apparatus, the transmission/reception method including:

by the communication apparatus,

acquiring firstly device identification information from the coordination apparatus, the device identification information identifying the coordination apparatus;

transmitting firstly to the service offering apparatus the user identification information input by an input part of the communication apparatus inputting the user identification information identifying the user ready to receive the service from the service offering apparatus, and the device identification information acquired firstly;

receiving firstly from the service offering apparatus authorization information indicating that the coordination of the coordination apparatus is authorized upon offering of the service in response to the transmission of the user identification information and the device identification information;

notifying the coordination apparatus of the authorization information received;

by the service offering apparatus,

receiving secondly the device identification information and the user identification information from the communication apparatus;

performing control to store the device identification information in association with the user identification information;

transmitting secondly to the communication apparatus the authorization information in response to the storage of the device identification information in association with the user identification information;

acquiring secondly from the coordination apparatus the authorization information received by the communication apparatus and communicated to the coordination apparatus;

supplying firstly the coordination apparatus with coordination use information to be used by the coordination apparatus upon offering of the service in accordance with the authorization information acquired;

by the coordination apparatus,

supplying secondly the device identification information to the communication apparatus;

transmitting thirdly to the service offering apparatus the authorization information communicated from the communication apparatus; and

receiving thirdly from the service offering apparatus the coordination use information in response to the transmission of the authorization information.

The series of the processes described above may be executed either by hardware or by software. Where the processes are to be carried out by software, the programs constituting the software may be either incorporated beforehand in the dedicated hardware of the computer to be used or installed from a suitable program recording medium into a general-purpose personal computer or like equipment capable of executing diverse functions based on the installed programs.

### [Typical Configuration of the Computer]

### [Typical Configuration of the Computer]

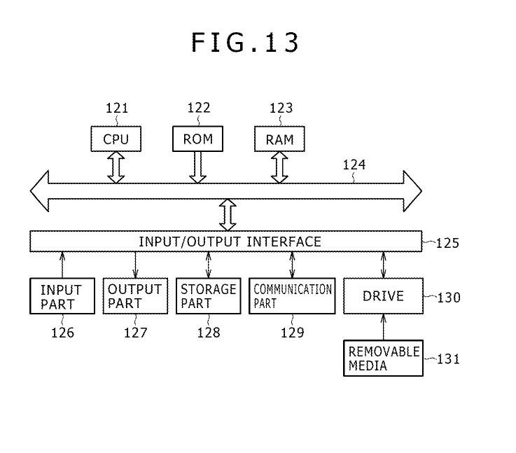

FIG. 13 is a block diagram showing a typical configuration of a computer that executes the series of the above-described processes using programs.

A CPU (central processing unit) 121 performs various processes in accordance with the programs stored in a ROM (read only memory) 122 or a storage part 128. A RAM (random access memory) 123 temporarily stores the programs and data to be executed by the CPU 121. The CPU 121, ROM 122, and RAM 123 are interconnected via a bus 124.

The CPU 121 is also connected with an input/output interface 125 via the bus 124. The input/output interface 125 is connected with an input part 126 generally made up of a keyboard, a mouse and a microphone, and with an output part 127 formed by a display device, speakers, etc. The CPU 121 performs diverse processing in response to the commands entered through the input part 126. The CPU 121 outputs the results of the processing to the output part 127.

The storage part 128 connected to the input/output interface 125 is typically composed of a hard disk and stores the programs and various data to be executed by the CPU 121. A communication part 129 communicates with an external apparatus via networks such as the Internet and local area networks.

Alternatively, programs may be acquired via the communication part 129 and stored into the storage part 128.

A drive 130 connected to the input/output interface 125 is loaded with removable media 131 such as a magnetic disk, an optical disk, a magneto-optical disk, or a semiconductor memory. The drive 130 drives the loaded medium to acquire the programs or data recorded thereon.

The programs and data thus acquired are transferred as needed to the storage part 128 for storage therein.

As shown in FIG. 13, the program recording media recording (storing) computer-installable, computer-executable programs are constituted either by the removable media 131 provided as package media such as magnetic disks (including flexible disks), optical disks (including CD-ROM (compact disc read-only memory) and DVD (digital versatile disc)), magneto-optical disks (including MD (Mini-Disc)), or a semiconductor memory; or by the ROM 122 or the hard disk drive making up the storage part 128 having the programs stored therein temporarily or permanently. The programs may be recorded to the program recording media via the communication part 129 such as a router or a modem interfaced with wired or wireless communication media including local area networks, the Internet, and digital satellite broadcasts.

In this specification, the steps describing the series of the processes discussed above include not only the processes that are to be carried out in the depicted sequence (i.e., on a time series basis) but also processes that may be performed parallelly or individually and not necessarily chronologically.

Also in this specification, the term “system” refers to an entire configuration made up of a plurality of component devices.

It should be understood that the present disclosure when embodied is not limited to the above-described embodiments and that various modifications, variations and alternatives may be made of the disclosure so far as they are within the scope of the appended claims or the equivalents thereof.

The present disclosure contains subject matter related to that disclosed in Japanese Priority Patent Application JP 2011-147931 filed in the Japan Patent Office on Jul. 4, 2011, the entire content of which is hereby incorporated by reference.

What is claimed is:

1. A communication apparatus comprising:
an input part configured to input user identification information identifying a user ready to receive a service offered by a service offering apparatus via a network;
an acquisition part configured to acquire device identification information from a coordination apparatus capable of offering said service in coordination with said service offering apparatus, said device identification information identifying said coordination apparatus;
a transmission part configured to transmit to said service offering apparatus said user identification information input by said input part and said device identification information acquired by said acquisition part;
a reception part configured to receive from said service offering apparatus authorization information indicating that the coordination of said coordination apparatus is authorized upon offering of said service in response to the transmission of said user identification information and said device identification information; and
a notification part configured to notify said coordination apparatus of said authorization information received.

2. The communication apparatus according to claim 1, wherein said notification part communicates the received authorization information to said coordination apparatus identified by said device identification information that is fixed.

3. The communication apparatus according to claim 1, wherein
said acquisition part acquires from said coordination apparatus said device identification information along with coordination side-generated information generated by said coordination apparatus, and
said transmission part transmits to said service offering apparatus said user identification information input by said input part, as well as said device identification information and said coordination side-generated information acquired by said acquisition part.

4. The communication apparatus according to claim 1, further comprising:
a supply part configured to supply said coordination apparatus with designated service information indicative of one of a plurality of services which is designated by said user;
wherein said acquisition part acquires said device identification information from said coordination apparatus capable of offering the service designated by said user in coordination with said service offering apparatus in response to the supply of said designated service information to said coordination apparatus.

5. A communication method for use with a communication apparatus communicating user identification information identifying a user, said communication method comprising:
acquiring through said communication apparatus device identification information from a coordination apparatus capable of offering a service in coordination with a service offering apparatus offering said service via a network, said device identification information identifying said coordination apparatus;
transmitting to said service offering apparatus said user identification information input by an input part of said communication apparatus inputting said user identification information identifying said user ready to receive said service from said service offering apparatus, and said device identification information acquired;
receiving from said service offering apparatus authorization information indicating that the coordination of said coordination apparatus is authorized upon offering of said service in response to the transmission of said user identification information and said device identification information; and
notifying said coordination apparatus of said authorization information received.

6. A program for causing a computer to function as an apparatus comprising:
an acquisition part configured to acquire device identification information from a coordination apparatus capable of offering a service in coordination with a service offering apparatus offering said service via a network, said device identification information identifying said coordination apparatus;
a transmission control part configured to transmit to said service offering apparatus said user identification information input by an input part of said communication apparatus inputting said user identification information identifying a user ready to receive said service from said service offering apparatus, and said device identification information acquired by said acquisition part;
a reception control part configured to receive from said service offering apparatus authorization information indicating that the coordination of said coordination apparatus is authorized upon offering of said service in response to the transmission of said user identification information and said device identification information; and
a notification control part configured to notify said coordination apparatus of said authorization information received.

7. A service offering apparatus for offering a service via a network, said service offering apparatus comprising:
a reception part configured to receive device identification information and user identification information from a communication apparatus to which said user identification information identifying a user ready to receive said service is input and which is supplied with said device identification information identifying a coordination apparatus capable of offering said service in coordination with said service offering apparatus;
a storage control part configured to store said device identification information in association with said user identification information;
a transmission part configured to transmit to said communication apparatus authorization information indicating that the coordination of said coordination apparatus is authorized upon offering of said service in response to the storage of said device identification information in association with said user identification information;
an acquisition part configured to acquire from said coordination apparatus said authorization information received by said communication apparatus and communicated to said coordination apparatus; and
a supply part configured to supply said coordination apparatus with coordination use information to be used by said coordination apparatus upon offering of said service in accordance with said authorization information acquired.

8. The service offering apparatus according to claim 7, wherein
said coordination apparatus generates coordination side-generated information indicative of a random character string,
said acquisition part acquires from said coordination apparatus the first coordination side-generation information and the first device identification information,
said reception part receives the second coordination side-generated information and the second device identification information from said communication apparatus to which the second coordination side-generated information is supplied by said coordination apparatus, and
upon coincidence between the acquired first coordination side-generated information and first device identification information on the one hand and the received second coordination side-generated information and second device identification information on the other hand, said storage control part stores said device identification information in association with said user identification information.

9. The service offering apparatus according to claim 7, further comprising:
a generation part configured to generate service side-generated information indicative of a random character string; and
another transmission part configured to transmit the first service side-generated information to said coordination apparatus;
wherein said acquisition part acquires the first authorization information and the second service side-generated information from said coordination apparatus having received the second service side-generated information from said other transmission part, and
upon coincidence between the first service side-generated information and the second authorization information transmitted to said communication apparatus on the one hand and said second service side-generated information and said second authorization information on the other hand, said supply part supplies said coordination apparatus with said coordination use information.

10. The service offering apparatus according to claim 7, further comprising:
another reception part configured to receive from coordination apparatus said device identification information and designated service information indicative of the service designated by the user of said communication apparatus; and
a determination part configured to determine whether said coordination apparatus can coordinate when the service designated by said designated service information is offered, on the basis of said device identification information received from said coordination apparatus;
wherein said supply part supplies said coordination apparatus with a result of the determination made by said determination part.

11. A service offering method for use with a service offering apparatus offering a service via a network, said service offering method comprising:
receiving device identification information and user identification information from a communication apparatus to which said user identification information identifying a user ready to receive said service is input and which is supplied with said device identification information identifying a coordination apparatus capable of offering said service in coordination with said service offering apparatus;
performing control to store said device identification information in association with said user identification information;
transmitting to said communication apparatus authorization information indicating that the coordination of said coordination apparatus is authorized upon offering of said service in response to the storage of said device identification information in association with said user identification information;
acquiring from said coordination apparatus said authorization information received by said communication apparatus and communicated to said coordination apparatus; and
supplying said coordination apparatus with coordination use information to be used by said coordination apparatus upon offering of said service in accordance with said authorization information acquired.

12. A program for causing a computer of a service offering apparatus offering a service via a network to function as an apparatus comprising:
a reception control part configured to receive device identification information and user identification information from a communication apparatus to which said user identification information identifying a user ready to receive said service is input and which is supplied with said device identification information identifying a coordination apparatus capable of offering said service in coordination with said service offering apparatus;
a storage control part configured to store said device identification information in association with said user identification information;
a transmission control part configured to transmit to said communication apparatus authorization information indicating that the coordination of said coordination apparatus is authorized upon offering of said service in response to the storage of said device identification information in association with said user identification information;
an acquisition control part configured to acquire from said coordination apparatus said authorization information received by said communication apparatus and communicated to said coordination apparatus; and
a supply control part configured to supply said coordination apparatus with coordination use information to be used by said coordination apparatus upon offering of said service in accordance with said authorization information acquired.

13. A coordination apparatus capable of offering a service in coordination with a service offering apparatus offering said service via a network, said coordination apparatus comprising:
a supply part configured to supply device identification information identifying said coordination apparatus to a communication apparatus to which user identification information identifying a user ready to receive said service is input;
a transmission part configured to transmit to said service offering apparatus authorization information which is communicated from said communication apparatus and which indicates that the coordination of said coordination apparatus is authorized upon offering of said service; and
a reception part configured to receive from said service offering apparatus coordination use information to be used for coordination with said service offering apparatus in response to the transmission of said authorization information.

14. The coordination apparatus according to claim 13, wherein
said reception part receives from said service offering apparatus service side-generated information generated by said service offering apparatus, and
said transmission part transmits to said service offering apparatus said authorization information communicated from said communication apparatus along with said service side-generated information received.

15. The coordination apparatus according to claim 13, wherein
said transmission part transmits designated service information and said device identification information to said service offering apparatus offering said service designated by said designated service information received from said communication apparatus,
said reception part receives, from said service offering apparatus having received said designated service information and said device identification information, a result of the determination of whether the coordination of said coordination apparatus is possible on the basis of said designated service information and said device identification information, and
said supply part supplies said communication apparatus with said device identification information in response to the receipt of the result of the determination that the coordination of said coordination apparatus is possible.

16. A coordination method for use with a coordination apparatus capable of offering a service in coordination with a service offering apparatus offering said service via a network, said coordination method comprising:
supplying device identification information identifying said coordination apparatus to a communication apparatus to which user identification information identifying a user ready to receive said service is input;
transmitting to said service offering apparatus authorization information which is communicated from said communication apparatus and which indicates that the coordination of said coordination apparatus is authorized upon offering of said service; and
receiving from said service offering apparatus coordination use information to be used for coordination with said service offering apparatus in response to the transmission of said authorization information.

17. A program for causing a computer of a coordination apparatus capable of offering a service in coordination with a service offering apparatus offering said service via a network to function as an apparatus comprising:
a supply control part configured to supply device identification information identifying said coordination apparatus to a communication apparatus to which user identification information identifying a user ready to receive said service is input;
a transmission control part configured to transmit to said service offering apparatus authorization information which is communicated from said communication apparatus and which indicates that the coordination of said coordination apparatus is authorized upon offering of said service; and
a reception control part configured to receive from said service offering apparatus coordination use information to be used for coordination with said service offering apparatus in response to the transmission of said authorization information.

18. A transmission/reception system comprising:
a communication apparatus communicating user identification information identifying a user;
a service offering apparatus offering a service to said user via a network; and
a coordination apparatus capable of coordinating with said service offering apparatus;
said communication apparatus including
an input part configured to input said user identification information identifying said user ready to receive said service offered by said service offering apparatus,
a first acquisition part configured to acquire device identification information from said coordination apparatus, said device identification information identifying said coordination apparatus,
a first transmission part configured to transmit to said service offering apparatus said user identification information input by said input part and said device identification information acquired by said first acquisition part,
a first reception part configured to receive from said service offering apparatus authorization information indicating that the coordination of said coordination apparatus is authorized upon offering of said service in response to the transmission of said user identification information and said device identification information, and
a notification part configured to notify said coordination apparatus of said authorization information received,
said service offering apparatus including
a second reception part configured to receive said device identification information and said user identification information from said communication apparatus,
a storage control part configured to store said device identification information in association with said user identification information,
a second transmission part configured to transmit to said communication apparatus said authorization information in response to the storage of said device identification information in association with said user identification information,
a second acquisition part configured to acquire from said coordination apparatus said authorization information received by said communication apparatus and communicated to said coordination apparatus, and
a first supply part configured to supply said coordination apparatus with coordination use information to be used by said coordination apparatus upon offering of said service in accordance with said authorization information acquired, and
said coordination apparatus including
a second supply part configured to supply said device identification information to said communication apparatus,
a third transmission part configured to transmit to said service offering apparatus said authorization information communicated from said communication apparatus, and
a third reception part configured to receive said coordination use information from said service offering apparatus in response to the transmission of said authorization information.

19. A transmission/reception method for use with a transmission/reception system including a communication apparatus communicating user identification information identifying a user, a service offering apparatus offering a service to said user via a network, and a coordination apparatus capable of coordinating with said service offering apparatus, said transmission/reception method comprising:
by said communication apparatus,
acquiring firstly device identification information from said coordination apparatus, said device identification information identifying said coordination apparatus;
transmitting firstly to said service offering apparatus said user identification information input by an input part of said communication apparatus inputting said user identification information identifying said user ready to receive said service from said service offering apparatus, and said device identification information acquired firstly;
receiving firstly from said service offering apparatus authorization information indicating that the coordination of said coordination apparatus is authorized upon offering of said service in response to the transmission of said user identification information and said device identification information;
notifying said coordination apparatus of said authorization information received;
by said service offering apparatus,
receiving secondly said device identification information and said user identification information from said communication apparatus;
performing control to store said device identification information in association with said user identification information;
transmitting secondly to said communication apparatus said authorization information in response to the storage of said device identification information in association with said user identification information;
acquiring secondly from said coordination apparatus said authorization information received by said communication apparatus and communicated to said coordination apparatus;
supplying firstly said coordination apparatus with coordination use information to be used by said coordination apparatus upon offering of said service in accordance with said authorization information acquired;
by said coordination apparatus,
supplying secondly said device identification information to said communication apparatus;
transmitting thirdly to said service offering apparatus said authorization information communicated from said communication apparatus; and
receiving thirdly from said service offering apparatus said coordination use information in response to the transmission of said authorization information.
